(19) United States
(12) Patent Application Publication
(10) Pub. No.: US 2009/0125630 A1
(43) Pub. Date: May 14, 2009

(54) METHOD AND APPARATUS FOR DEFINING A SEARCH WINDOW BASED ON DISTANCE BETWEEN ACCESS POINTS

(75) Inventor: Aleksandar M. Gogic, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/266,225

(22) Filed: Nov. 6, 2008

Related U.S. Application Data
(60) Provisional application No. 60/986,953, filed on Nov. 9, 2007.

(51) Int. Cl. G06F 15/16

(52) U.S. Cl. 709/227

(57) ABSTRACT

An access terminal defines a search window based on a distance between access points. Here, a first one of the access points may comprise a macro access point from which the access terminal acquires timing. The search window may be used to monitor for pilot signals from a second one of the access points. For example, the second access point may comprise a femto node that provides relatively small area coverage. In some aspects the definition of the search window may involve adjusting (e.g., advancing) a center of a search window based on the distance between the access points. In addition, the access terminal may employ a smaller search window when it is searching for pilot signals from a femto node as compared to when it is searching for pilot signals from a macro access point.

### CLAIM OF PRIORITY UNDER 35 U.S.C. §119

This application claims the benefit of and priority to commonly owned U.S. Provisional Patent Application No. 60/986,953, filed Nov. 9, 2007, and assigned Attorney Docket No. 080218P1, the disclosure of which is hereby incorporated by reference herein.

### BACKGROUND

1. Field

This application relates generally to wireless communication and more specifically, but not exclusively, to defining a search window.

2. Introduction

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

To supplement conventional mobile phone network base stations (e.g., macro cells), small-coverage base stations may be deployed (e.g., installed in a user's home) to provide more robust indoor wireless coverage to mobile units. Such small-coverage base stations are generally known as access point base stations, Home NodeBs, or femto cells. Typically, such small-coverage base stations are connected to the Internet and the mobile operator's network via a DSL router or a cable modem.

In some femto cell deployments there may be a relatively large number of femto cells in the territory covered by a macro cell. In such a case, when a mobile unit is monitoring the macro system, the mobile unit may end up searching a large number of neighboring femto cells within the femto cell search space. Conducting such a large number of searches may, however, diminish the battery life of the mobile unit (e.g., thereby reducing stand-by time).

### SUMMARY

A summary of sample aspects of the disclosure follows. It should be understood that any reference to the term aspects herein may refer to one or more aspects of the disclosure.

The disclosure relates in some aspect to defining a search window based on the distance between two access points. For example, an access terminal that is acquiring its timing from a macro access point may define a search window for searching for a femto node based on the distance between the macro access point and the femto node.

In some aspects, the definition of the search window comprises adjusting (e.g., advancing) the center of the search window. For example, the farther away that the femto node is from the macro access point, the farther the center of the search window may be advanced.

The disclosure relates in some aspect to providing a shorter search window for searching for access points (e.g., femto or pico nodes) that provide smaller area coverage. Here, a shorter search window may be employed because the access terminal may only receive signals from the small area coverage access point when the access terminal is relatively close to that access point. By utilizing shorter search times, a nearby access point may be acquired more quickly and fewer access terminal resources may be used to perform searches. Consequently, the access terminal may consume less power which will, in turn, extend the battery life of the access terminal.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system wherein an access terminal defines a search window based on the distance between access points;

FIG. 2 is a simplified diagram illustrating sample coverage areas for wireless communication;

FIG. 3 is a simplified diagram of a wireless communication system including access points and access terminals;

FIG. 4 is a simplified diagram of a wireless communication system including femto nodes;

FIG. 5 is a simplified diagram illustrating signal timing relationships in a wireless communication system;

FIG. 6 is a flowchart of several sample aspects of operations that may be performed to define a search window based on the distance between access points;

FIG. 7 is a simplified block diagram of several sample components of a node configured to define a search window based on the distance between access points;

FIG. 8 is a simplified block diagram of several sample aspects of communication components; and

FIG. 9 is simplified block diagram of several sample aspects of an apparatus configured to define a search window based on the distance between access points as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

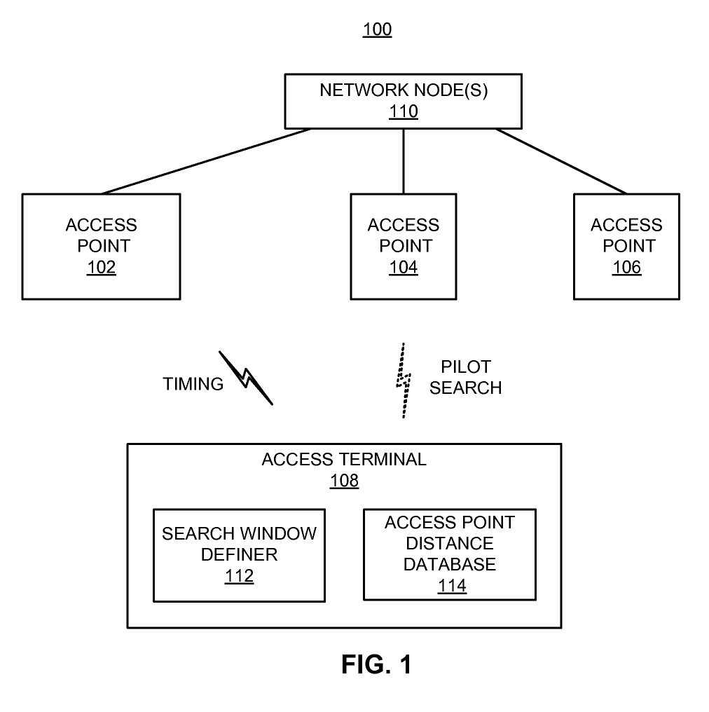

FIG. 1 illustrates several nodes in a sample communication system 100 (e.g., a portion of a communication network). For illustration purposes, various aspects of the disclosure will be described in the context of one or more access terminals, access points, and network nodes that communicate with one another. It should be appreciated, however, that the teachings herein may be applicable to other types of apparatuses or other similar apparatuses that are referenced using other terminology.

Access points 102-106 in the system 100 provide one or more services (e.g., network connectivity) for one or more wireless terminals (e.g., access terminal 108) that may be installed within or that may roam throughout an associated geographical area. In addition, the access points 102-106 may communicate with one or more network nodes (represented, for convenience, by network node 110) to facilitate wide area network connectivity. Such network nodes may take various forms such as, for example, one or more radio and/or core network entities (e.g., a configuration manager, a mobility management entity, or some other suitable network entity).

FIG. 1 and the discussion that follows describe a search scheme where the access terminal 108 defines a search window based on the distance between two access points (e.g., access points 102 and 104). Here, the access point 102 may comprise a macro access point from which the access terminal 108 acquires timing. In other words, the access terminal 108 synchronizes its timing to the timing of the system 100 by synchronizing to the timing of the access point 102. Consequently, the access terminal 108 will use this acquired timing to determine when and where to search for signals (e.g., pilot signals) transmitted by other access points (e.g., the access point 104) in the system 100. To compensate for propagation delays associated with the transmission of signals from the access points 102 and 104 to the access terminal 108, the access terminal 108 defines a search window at an appropriate time offset and with sufficient width to ensure that the access terminal 108 monitors for signals from the access point 104 where these signals are expected to appear at the access terminal 108.

In some aspects, the definition of the search window takes into account that the access point 104 (e.g., a femto node) may have a smaller coverage area than the access point 102. In such a case, the access terminal 108 may advantageously employ a smaller search window since the access terminal 108 may only receive signal of sufficient strength from the access point 104 when it is relatively close to the access point 104. As will be described in more detail below, the access terminal 108 (e.g., a search window definer 112) may define this search window based on the distance between the access points 102 and 104 (e.g., as maintained in a database 114).

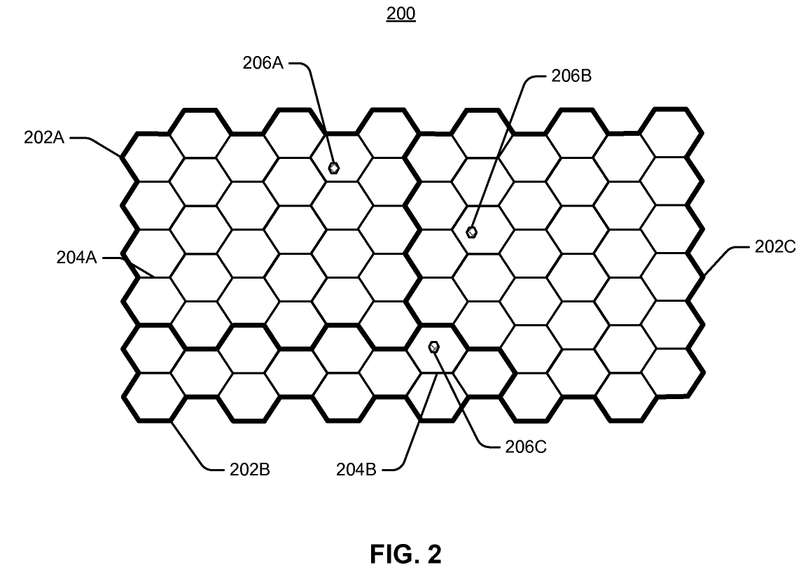

FIG. 2 illustrates an example of how different access points having different coverage areas may be deployed in a network 200. Here, the network 200 may provide macro coverage 204 (e.g., a large area cellular network such as a 3G network, typically referred to as a macro cell network or a WAN) and smaller area coverage 206 (e.g., a residence-based or building-based network environment, typically referred to as a LAN). As an access terminal moves through such a network, the access terminal may be served in certain locations by access points that provide macro coverage while the access terminal may be served at other locations by access points that provide smaller area coverage. In some aspects, the smaller coverage nodes may be used to provide incremental capacity growth, in-building coverage, and different services (e.g., for a more robust user experience).

In the description herein, a node that provides coverage over a relatively large area may be referred to as a macro node (or macro access point) while a node that provides coverage over a relatively small area (e.g., a residence) may be referred to as a femto node. It should be appreciated that the teachings herein may be applicable to nodes associated with other types of coverage areas. For example, a pico node may provide coverage over an area that is smaller than a macro area and larger than a femto area (e.g., coverage within a commercial building). In various applications, other terminology may be used to reference a macro node, a femto node, or other access point-type nodes. For example, a macro node may be configured or referred to as an access node, base station, access point, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively.

In the example of FIG. 2, several tracking areas 202 (or routing areas or location areas) are defined, each of which includes several macro coverage areas 204. Here, areas of coverage associated with tracking areas 202A, 202B, and 202C are delineated by the wide lines and the macro coverage areas 204 are represented by the hexagons. As mentioned above, the tracking areas 202 also may include femto coverage areas 206. In this example, each of the femto coverage areas 206 (e.g., femto coverage area 206C) is depicted within a macro coverage area 204 (e.g., macro coverage area 204B). It should be appreciated, however, that a femto coverage area 206 may not lie entirely within a macro coverage area 204. Also, one or more pico or femto coverage areas (not shown) may be defined within a given tracking area 202 or macro coverage area 204.

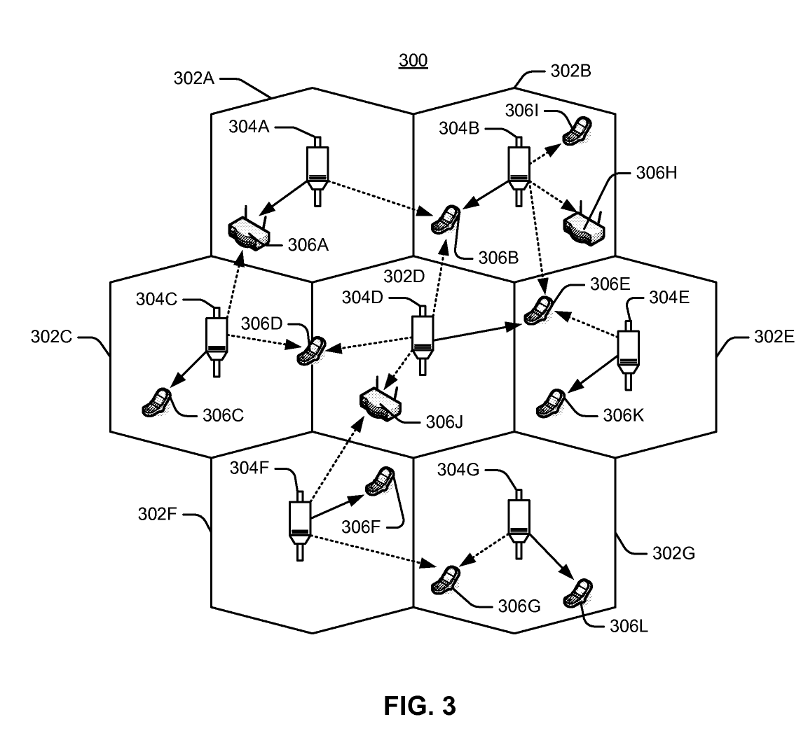

FIG. 3 illustrates, in a simplified manner, how the cells 302 (e.g., macro cells 302A-302G) of a wireless communication system 300 may serviced by corresponding access points 304 (e.g., access points 304A-304G). Here, the macro cells 302 may correspond to the macro coverage areas 204 of FIG. 2. As shown in FIG. 3, access terminals 306 (e.g., access terminals 306A-306L) may be dispersed at various locations throughout the system over time. Each access terminal 306 may communicate with one or more access points 304 on a forward link (“FL”) and/or a reverse link (“RL) at a given moment, depending upon whether the access terminal 306 is active and whether it is in soft handoff, for example. Through the use of this cellular scheme, the wireless communication system 300 may provide service over a large geographic region. For example, each of the macro cells 302A-302G may cover a few blocks in a neighborhood or several square miles in rural environment.

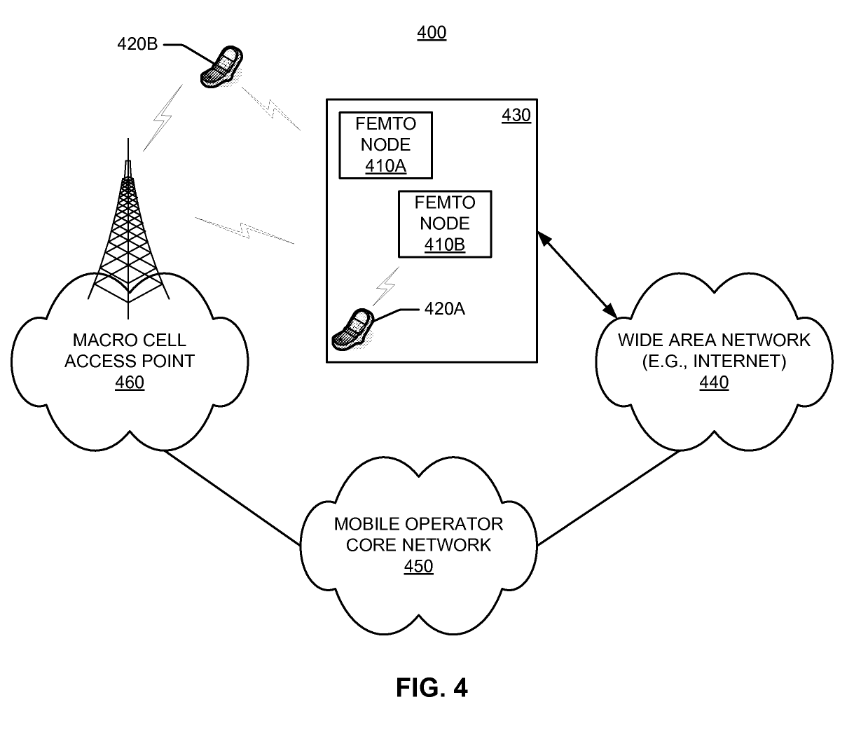

FIG. 4 illustrates an example how one or more femto nodes may be deployed within a network environment (e.g., the system 300). In the system 400 of FIG. 4, multiple femto nodes 410 (e.g., femto nodes 410A and 410B) are installed in a relatively small area coverage network environment (e.g., in one or more user residences 430). Each femto node 410 may be coupled to a wide area network 440 (e.g., the Internet) and a mobile operator core network 450 via a DSL router, a cable modem, a wireless link, or other connectivity means (not shown).

The owner of a femto node 410 may subscribe to mobile service, such as, for example, 3G mobile service, offered through the mobile operator core network 450. In addition, an access terminal 420 may be capable of operating both in macro environments and in smaller area coverage (e.g., residential) network environments. In other words, depending on the current location of the access terminal 420, the access terminal 420 may be served by a macro cell access point 460 associated with the mobile operator core network 450 or by any one of a set of femto nodes 410 (e.g., the femto nodes 410A and 410B that reside within a corresponding user residence 430). For example, when a subscriber is outside his home, the subscriber may be served by a standard macro access point (e.g., access point 460) and when the subscriber is near or inside his home, the subscriber may be served by a femto node (e.g., node 410A). Here, a femto node 410 may be backward compatible with legacy access terminals 420.

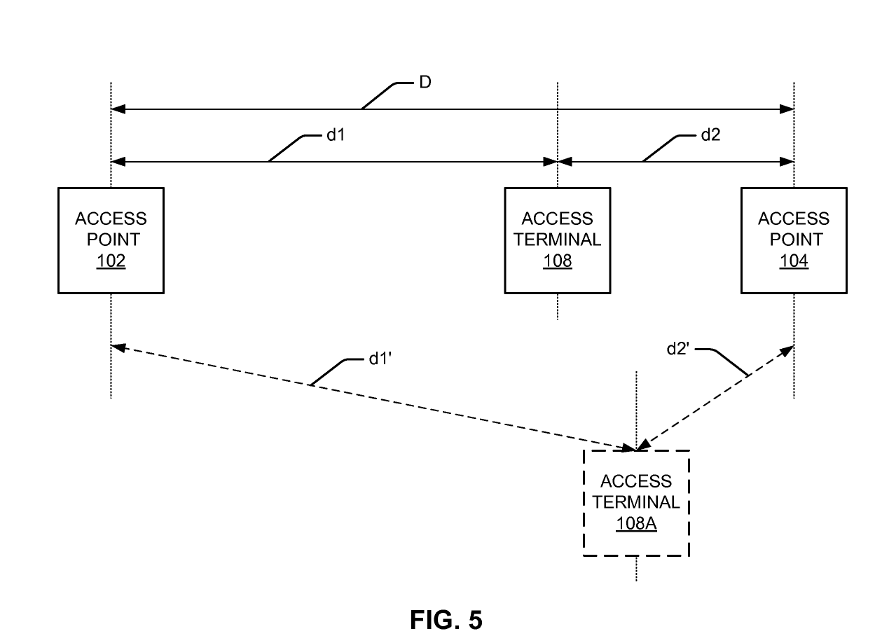

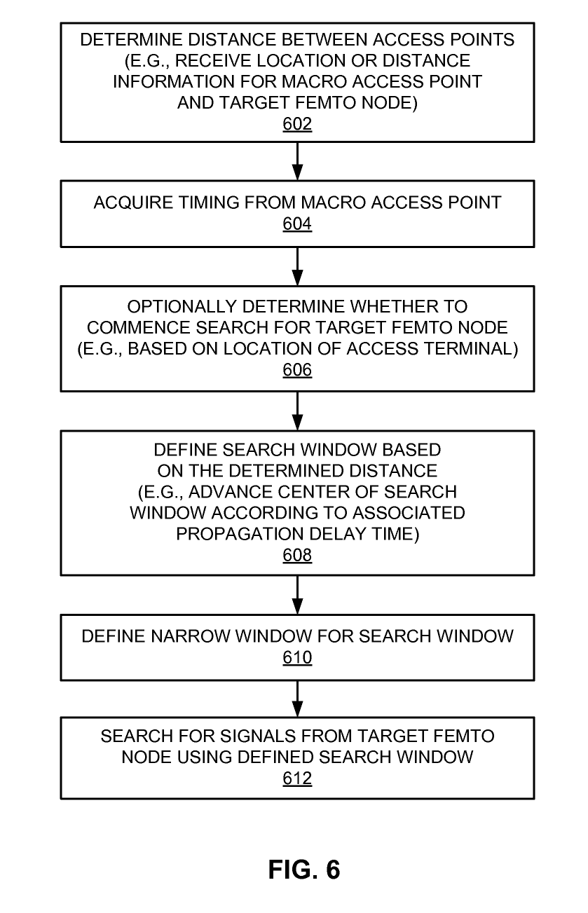

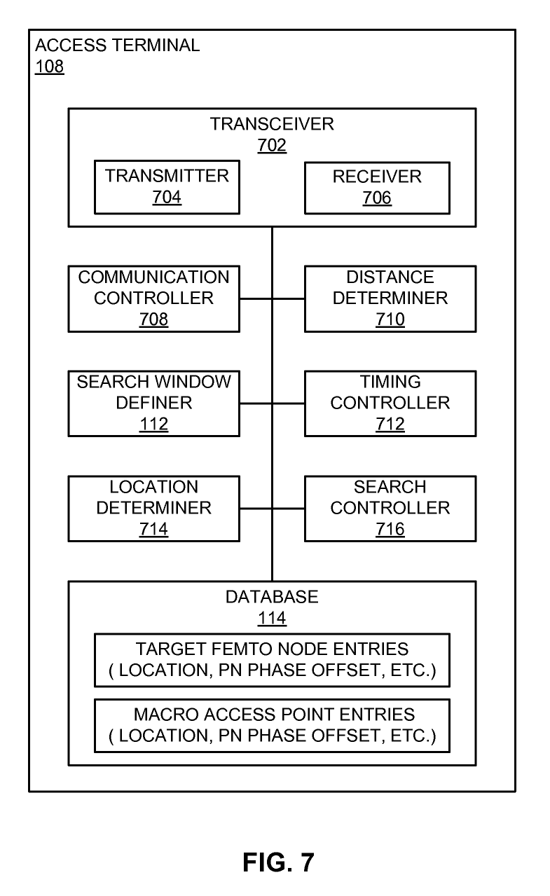

With the above overview in mind, additional details relating to a search scheme that may be implemented in accordance with the teachings herein will now be described with reference to FIGS. 5-7. FIG. 5 illustrates several timing relationships between nodes in a system. FIG. 6 describes sample operations that may be performed in conjunction with searching for signals from one or more access points. FIG. 7 illustrates several sample components that may be employed in a node to facilitate such a search scheme.

In FIG. 5 the access points 102 and 104 are separated by a distance D and the access terminal 108 may be located anywhere in a three-dimensional space in the vicinity about the access points 102 and 104. For purposes of discussion, however, it is initially assumed that the access terminal 108 lies somewhere along an imaginary straight line between the access points 102 and 104. Hence, the sum of the distance d1 (between the access point 102 and the access terminal 108) and the distance d2 (between the access point 104 and the access terminal 108) is equal to D.

As mentioned above, the access terminal 108 receives timing signals from the access point 102. Due to signal propagation delay, however, the time reference at the access terminal 108 may be different than the time reference at the access point 102. Specifically, the time at the access terminal 108 will lag the time at the access point 102, and will be approximately: t−d1/c, where t is the time at the access point 102 and c is the speed of light.

Also due to signal propagation delay, the time at which the access terminal 108 receives a pilot signal from the access point 104 will lag the time at which the access point 104 transmitted the pilot signal by approximately: d2/c. Here it is assumed that the time t is approximately the time at the access point 104 (which is synchronized with the time at the access point 102, within a certain tolerance). Thus, from the perspective of the time reference at the access terminal 108, the pilot signal from the access point 104 is received at the access terminal 108 delayed by a phase lag of: (d2−d1)/c. It should be appreciated that the maximum phase lag here is D/c. It should also be appreciated that this phase lag relationship holds even when the access terminal is not located along a straight line connecting the access points 102 and 104. That is, for the access terminal 108A shown in phantom, the phase lag is (d2′−d1′)/c and the maximum possible phase lag is still D/c.

If the access points 102 and 104 both provide large area coverage, the search window for the access terminal 108 may be defined equal to the maximum possible phase lag. In this way, regardless of whether the access terminal 108 is closer to the access point 102 or the access point 104, the access terminal 108 may be able to acquire the pilot signals transmitted by the access point 104 during the search window.

Referring now to FIGS. 6 and 7, a search scheme that may advantageously provide a smaller search window in the event the access point 104 provides relatively small area coverage is described. Here, a smaller sized search window may be used because the search window does not need to account for scenarios where the access terminal 108 is not relatively close to the access point 104. In other words, the access terminal 108 will not receive pilot signal of sufficient strength from the access point 104 when it is far away from the access point 104. Consequently, the size of the search window may be reduced to avoid searching in the phase space where the access terminal 108 would not be receiving pilot signal from the access point 104. As will be described in more detail below, the distance between the access points 102 and 104 is used to define a search window (e.g., to specify the appropriate time for the center of the search window) and a smaller search window (e.g., corresponding to the relative timing tolerance of the access points 102 and 104) may then be used by the access terminal 108 when searching for pilot signal from the access point 104.

For illustration purposes, the operations of FIG. 6 (or any other operations discussed or taught herein) may be described as being performed by specific components (e.g., components of the system 100 and/or the access terminal components as shown in FIG. 7). It should be appreciated, however, that these operations may be performed by other types of components and may be performed using a different number of components. It also should be appreciated that one or more of the operations described herein may not be employed in a given implementation.

FIG. 7 illustrates several sample components that may be incorporated into nodes such as the access terminal 108 to perform search operations as taught herein. The described components also may be incorporated into other nodes in a communication system. For example, other nodes in a system may include components similar to those described for access terminal 108 to provide similar functionality. A given node may contain one or more of the described components. For example, an access terminal may contain multiple transceiver components that enable the access terminal to operate on multiple frequencies and/or communicate via different technology.

As shown in FIG. 7, the access terminal 108 may include a transceiver 702 for communicating with other nodes. The transceiver 702 includes a transmitter 704 for sending signals (e.g., messages) and a receiver 706 for receiving signals (e.g., including conducting searches for pilot signals).

The access terminal 108 also includes other components that may be used in conjunction with search operations as taught herein. For example, the access terminal 108 may include a communication controller 708 for managing communication with other nodes (e.g., sending and receiving messages/indications) and for providing other related functionality as taught herein. The access terminal 108 may include a distance determiner 710 for determining the distance between access points and for providing other related functionality as taught herein. The access terminal 108 may include a search window definer 112 (as discussed above) for defining a search window and for providing other related functionality as taught herein. The access terminal 108 may include a timing controller 712 for acquiring and providing timing and for providing other related functionality as taught herein. The access terminal 108 may include a location determiner 714 for determining the location of the access terminal 108 and for providing other related functionality as taught herein. The access terminal 108 may include a search controller 716 for controlling search operations and for providing other related functionality as taught herein.

Referring now to the operations of FIG. 6, as represented by block 602, the access terminal 108 (e.g., the distance determiner 710) determines the distance between the access points 102 and 104. To this end, the access terminal 108 may receive information from another node indicative of this distance.

In some implementations the access terminal 108 may receive information that explicitly indicates the distance between the access points 102 and 104. For example, one of these access points or some other node in the system may maintain this information and send it to access terminal 108 at some point in time. As a specific example, when a given femto node is configured, the distance to a neighboring macro access point (e.g., the closest macro access point) may be computed and stored at the femto node. This distance information may then be conveyed to the access terminal 108 when the access terminal 108 connects to the network or at some other time. As another example, the network may comprise one or more network entities (e.g., as represented by the network node 110 in FIG. 1) that facilitate configuring the femto nodes. For example, such an entity may maintain information (e.g., location information) for various nodes (e.g., macro access points and femto nodes) in the network. In various implementations such an entity may be implemented as a stand-alone component or integrated into other common network components.

In some implementations the access terminal 108 may receive information that is indicative of the locations of the access points 102 and 104. In such a case, the access terminal may calculate the distance between the access point 102 and 104 based on this location information. Since the access points 102 and 104 may be stationary, the access terminal 108 may perform this computation one time and store the results in the database 114.

The access terminal 108 may perform exploratory searches for access points with the purpose of finding out if there is a new access point that access terminal 108 may be able to use at its current location. For example, if upon conducting such an exploratory search the access terminal 108 finds a new femto node, the access terminal 108 may update the database 114. When the access terminal 108 finds a new femto node as a result of an exploratory search, the access terminal 108 may be aware of locations of both the macro access point 102 (its current serving cell) and the femto node. For example, the locations of both may be transmitted in overhead messages. Hence, the access terminal 108 may be able to compute the distance between these access points and store this information in the database 114 along with other pertinent information about the newly discovered femto node.

The location of a given target femto node may be determined or ascertained when the femto node is configured. The location of the femto node may be transmitted by the femto node via a control channel. When the access terminal 108 acquires a host femto node (or any other femto node at which the access terminal 108 may obtain service), for example upon conducting an exploratory search, the access terminal 108 may receive this location information.

As mentioned above, the access terminal 108 may maintain a database 114 that includes entries for target femto cells that the access terminal 108 may search for at some point in time. In a typical case, a target femto cell may comprise a designated host femto node (e.g., a femto node installed in the home of the user of the access terminal 108).

The database 114 entries also may include information related to macro access points in the network. In particular, there may be information elements on macro access points that are close to the target femto nodes specified in the database. For example, for each target femto node, the database 114 may include an element that identifies a macro access point that the access terminal 118 may use to acquire system timing when it is on the macro cellular network in the vicinity of that target femto node. In some cases, this macro access point may be the access point that is closest to the target femto node. For convenience, the macro access point may be referred to as the “mother cell” herein while the corresponding target femto node may be referred to as the “daughter cell.”

The database 114 may include various types of information that enables the access terminal 108 to identify signals from a given access point and determine its location. For example, this information may include the phase offset of a pseudorandom number (“PN”) sequence used by an access point when transmitting a pilot signal, the latitude and longitude of the access point, an access point identifier (e.g., a femto ID), and other information that identifies the access point.

In some implementations the access terminal 108 may autonomously acquire the database information. For example, as mentioned above the access terminal 108 may automatically attempt to acquire this information when it accesses an access point in the network, or when it finds a new access point as a result of exploratory searching.

In some implementations the access terminal 108 may obtain the database information in a less autonomous manner. For example, this information may be securely downloaded by network action or may be downloaded by other means under control of a user of the access terminal 108 or the operator of a wireless network.

As represented by block 604 of FIG. 6, at some point in time when in idle mode or active mode (e.g., on a call) the access terminal 108 (e.g., the timing controller 712) may acquire timing from the access point 102. For example, as the access terminal 108 roams through the network, the access terminal 108 may acquire system timing from the closest macro access point (e.g., the macro access point associated with the strongest receive signal strength).

As represented by block 606, the access terminal 108 may optionally monitor its location to determine whether it should commence a search for one or more of the target femto nodes. For example, the search controller 716 may monitor the current location of the access terminal 108 as provided by the location determiner 714 and compare this location with the locations of the target femto nodes that are stored in the database 114. In the event the access terminal 108 is sufficiently close to one or more of the target femto nodes, the search controller 716 may commence a search for these target femto nodes.

It should be appreciated that the access terminal 108 may alternatively be configured to search for target femto nodes in some other way. For example, the access terminal 108 may continually search for target femto nodes in some implementations, or it may conduct such a search only if it is in idle or active mode being served by the mother cell or mother cells indicated by the contents of database 114.

As represented by block 608, the access terminal 108 (e.g., the search window definer 112) may define the search window to be used when searching for the target femto node (e.g., the access point 104) based on the distance between that target femto node and the macro access point (e.g., the access point 102) from which the access terminal 108 acquires timing.

As an example, as mentioned above the system time at the access terminal 108 may be derived from the access point 102. This time is delayed from the system time at the access point 102 by the propagation delay between the access point 102 and the access terminal 108. Since the access terminal 108 will not detect a femto node (access point 104) until it is very close to it, and since the access point 104 has the same system time as the access point 102 (e.g., except for a small calibration error), it follows that there will be a system time shift between the access terminal 108 (when it is on the access point 104) and the access point 104, which is approximately equal to the propagation delay between the access point 102 and the access point 104. This propagation delay may be computed based on the distance between the access point 102 and the access point 104. The access terminal 108 may then adjust (e.g., advance) the center of the search window by this amount of time.

As represented by block 610, by defining the timing of the center of the search window in this way, a relatively small search window may be used. For example, the width of the window may be on the order of a defined error tolerance in the timing of the access points 102 and 104. In other words, the error tolerance may be based on the maximum amount by which the system time of one access point in a network is permitted to differ from the system time of another access point in the network. In some implementations this timing error tolerance may be on the order of 3 microseconds. This window size may thus be much smaller than the size of a conventional search window (e.g., used for searching for macro access points) which, as discussed above, may correspond to the propagation delay value associated with the distance between macro cells.

As represented by block 612, once the search window is defined, the access terminal 108 (e.g., the search controller 716) may cooperate with the receiver 706 to monitor the appropriate frequency band or bands at the appropriate times, and to search over the appropriately centered narrow window. In this way, when the access terminal 108 is sufficiently close to the access point 104, the access terminal 108 may acquire signals transmitted by the access point 104.

The search scheme described above may be used to concurrently search for signals from several access points (e.g., femto nodes that may be located in the same general area within a mother cell coverage). For example, the access terminal 108 may concurrently search for signals from the access points 104 and 106. In this case, the access terminal 108 also will determine the distance between the access points 102 and 106 and will define a search window (e.g., the timing of the center of the search window) based on this distance. The access terminal 108 may then search for signals from the access point 106 using this search window concurrently with the search for signals from the access point 104 using the previously defined search window. Here, it should be appreciated that these searches may involve searching for different PN sequence phase offsets since the access points 104 and 106 will typically use different phase offsets to transmit their respective pilot signals.

In addition, the amount of overlap in time, if any, between these search windows will depend on the respective distances of each access point from the access point 102. For example, the two search windows may completely overlap if the distances are the same. In this case, the width of the overall search window for the access terminal 108 is equal to the width of one of the search windows. In contrast, the width of the overall search window for the access terminal 108 may be wider than the width of one of the search windows if the distances are different (e.g., one search window will be earlier in time than the other search window).

The teachings herein may be implemented in various types of communication devices. In some aspects, the teachings herein may be implemented in wireless devices that may be deployed in a multiple access communication system that may simultaneously support communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (“MIMO”) system, or some other type of system.

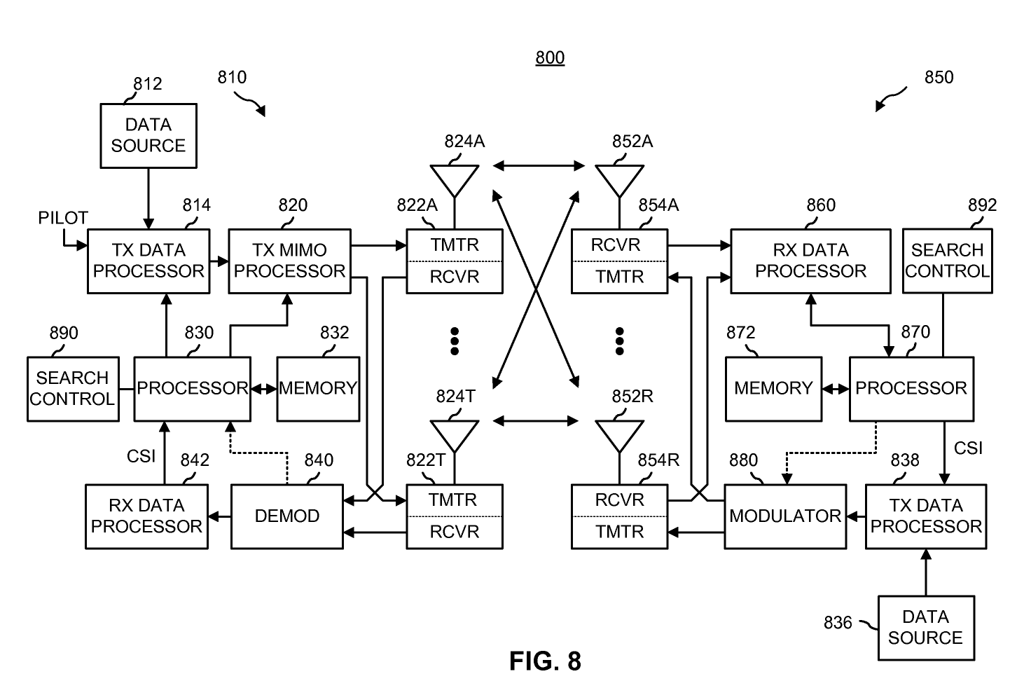

For illustration purposes, FIG. 8 describes sample communication components that may be employed in a wireless device in the context of a MIMO-based system 800. The system 800 employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The system 800 may provide improved performance (e.g., higher throughput and/or greater reliability) if the additional dimensionalities created by the multiple transmit and receive antennas are utilized.

The system 800 may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

The system 800 includes a wireless device 810 (e.g., an access point) and a wireless device 850 (e.g., an access terminal). At the device 810, traffic data for a number of data streams is provided from a data source 812 to a transmit (“TX”) data processor 814.

In some aspects, each data stream is transmitted over a respective transmit antenna. The TX data processor 814 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 830. A data memory 832 may store program code, data, and other information used by the processor 830 or other components of the device 810.

The modulation symbols for all data streams are then provided to a TX MIMO processor 820, which may further process the modulation symbols (e.g., for OFDM). The TX MIMO processor 820 then provides N_{T} modulation symbol streams to N_{T} transceivers (“XCVR”) 822A through 822T. In some aspects, the TX MIMO processor 820 applies beam-forming weights to the symbols of the data streams and to the antenna from which the symbol is being transmitted.

Each transceiver 822 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 822A through 822T are then transmitted from N_{T} antennas 824A through 824T, respectively.

At the device 850, the transmitted modulated signals are received by N_{R} antennas 852A through 852R and the received signal from each antenna 852 is provided to a respective transceiver (“XCVR”) 854A through 854R. Each transceiver 854 conditions (e.g., filters, amplifies, and downconverts) a respective received signal, digitizes the conditioned signal to provide samples, and further processes the samples to provide a corresponding “received” symbol stream.

A receive (“RX”) data processor 860 then receives and processes the N_{R} received symbol streams from N_{R} transceivers 854 based on a particular receiver processing technique to provide N_{T} “detected” symbol streams. The RX data processor 860 then demodulates, deinterleaves, and decodes each detected symbol stream to recover the traffic data for the data stream. The processing by the RX data processor 860 is complementary to that performed by the TX MIMO processor 820 and the TX data processor 814 at the device 810.

A processor 870 periodically determines which pre-coding matrix to use (discussed below). The processor 870 formulates a reverse link message comprising a matrix index portion and a rank value portion. A data memory 872 may store program code, data, and other information used by the processor 870 or other components of the device 850.

The reverse link message may comprise various types of information regarding the communication link and/or the received data stream. The reverse link message is then processed by a TX data processor 838, which also receives traffic data for a number of data streams from a data source 836, modulated by a modulator 880, conditioned by the transceivers 854A through 854R, and transmitted back to the device 810.

At the device 810, the modulated signals from the device 850 are received by the antennas 824, conditioned by the transceivers 822, demodulated by a demodulator (“DEMOD”) 840, and processed by a RX data processor 842 to extract the reverse link message transmitted by the device 850. The processor 830 then determines which pre-coding matrix to use for determining the beam-forming weights then processes the extracted message.

FIG. 8 also illustrates that the communication components may include one or more components that perform search control operations as taught herein. For example, a search control component 890 may cooperate with the processor 830 and/or other components of the device 810 to send/receive signals to/from another device (e.g., device 850) as taught herein. Similarly, a search control component 892 may cooperate with the processor 870 and/or other components of the device 850 to send/receive signals to/from another device (e.g., device 810). It should be appreciated that for each device 810 and 850 the functionality of two or more of the described components may be provided by a single component. For example, a single processing component may provide the functionality of the search control component 890 and the processor 830 and a single processing component may provide the functionality of the search control component 892 and the processor 870.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (“UTRA)”, cdma2000, or some other technology. UTRA includes W-CDMA and Low Chip Rate (“LCR”). The cdma2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11, IEEE 802.16, IEEE 802.20, Flash-OFDM®, etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (I×RTT, 1×EV-DO Re1O, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (“RNC”), a base station (“BS”), a radio base station (“RBS”), a base station controller (“BSC”), a base transceiver station (“BTS”), a transceiver function (“TF”), a radio transceiver, a radio router, a basic service set (“BSS”), an extended service set (“ESS”), or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

In some implementations, a node (e.g., a femto node) may be restricted in some way. For example, a given femto node may be configured to only provide certain services to certain access terminals. In deployments with so-called restricted (or closed) association, a given access terminal may only be served by the macro cell mobile network and a defined set of femto nodes (e.g., the femto nodes 410 that reside within the corresponding user residence 430 as shown in FIG. 4). For example, in FIG. 4 each femto node 410 may be configured to serve associated access terminals 420 (e.g., access terminal 420A) and, optionally, guest access terminals 420 (e.g., access terminal 420B). In other words, access to femto nodes 410 may be restricted whereby a given access terminal 420 may be served by a set of designated (e.g., home) femto node(s) 410 but may not be served by any non-designated femto nodes 410 (e.g., a neighbor's femto node 410).

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access points (e.g., femto nodes) that share a common access control list of access terminals. In some implementations, a node may be restricted to not provide, for at least one node, at least one of: signaling, data access, registration, paging, or service.

Various relationships may thus exist between a given femto node and a given access terminal. For example, from the perspective of an access terminal, an open femto node may refer to a femto node with open association (e.g., the femto node allows access to any access terminal). A restricted femto node may refer to a femto node that is restricted in some manner (e.g., restricted for association and/or registration). A home femto node may refer to a femto node on which the access terminal is authorized to access and operate on (e.g., permanent access is provided for a defined set of one or more access terminals). A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that is authorized to access the restricted femto node (e.g., the access terminal has permanent access to the femto node). A guest access terminal may refer to an access terminal with temporary access to the restricted femto node (e.g., limited based on deadline, time of use, bytes, connection count, or some other criterion or criteria). An alien access terminal may refer to an access terminal that does not have permission to access the restricted femto node, except for perhaps emergency situations, for example, such as 911 calls (e.g., an access terminal that does not have the credentials or permission to register with the restricted femto node).

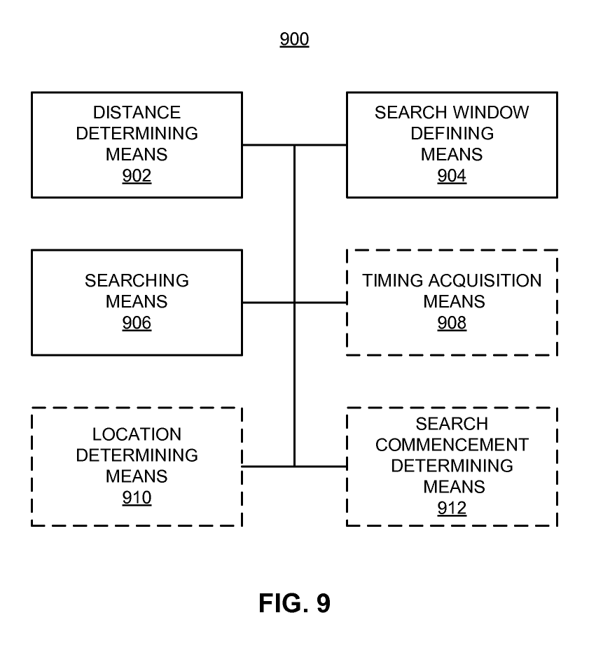

The components described herein may be implemented in a variety of ways. Referring to FIG. 9, an apparatus 900 is represented as a series of interrelated functional blocks. In some aspects the functionality of these blocks may be implemented as a processing system including one or more processor components. In some aspects the functionality of these blocks may be implemented using, for example, at least a portion of one or more integrated circuits (e.g., an ASIC). As discussed herein, an integrated circuit may include a processor, software, other related components, or some combination thereof. The functionality of these blocks also may be implemented in some other manner as taught herein. In some aspects one or more of the dashed blocks in FIG. 9 are optional.

The apparatus 900 may include one or more modules that may perform one or more of the functions described above with regard to various figures. For example, a distance determining means 902 may correspond to, for example, a distance determiner as discussed herein. A search window defining means 904 may correspond to, for example, a search window definer as discussed herein. A searching means 906 may correspond to, for example, a receiver as discussed herein. A timing acquisition means 908 may correspond to, for example, a timing controller as discussed herein. A location determining means 910 may correspond to, for example, a location determiner as discussed herein. A search commencement determining means 912 may correspond to, for example, a search controller as discussed herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In summary, it should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
determining a distance between a first access point and a second access point;
defining a search window based on the determined distance; and
searching for at least one signal from the first access point based on the defined search window.

2. The method of claim 1, wherein the definition of the search window comprises defining a center of the search window.

3. The method of claim 1, wherein the definition of the search window comprises adjusting timing of a center of the search window according to a propagation delay time associated with the determined distance.

4. The method of claim 1, further comprising acquiring timing from the second access point, wherein timing of the search window is based on the acquired timing.

5. The method of claim 1, wherein the determination of the distance comprises:
receiving a first indication of a location of the first access point;
receiving a second indication of a location of the second access point; and
calculating the distance based on the first and second indications.

6. The method of claim 1, wherein the determination of the distance comprises receiving an indication of the distance.

7. The method of claim 1, wherein the at least one signal comprises at least one pilot signal.

8. The method of claim 1, further comprising:
determining a location of an access terminal; and
determining whether to commence the search for the least one signal at the access terminal based on the determined location.

9. The method of claim 1, further comprising:
determining another distance between a third access point and the second access point;
defining the search window based on the determined another distance; and
searching for at least one other signal from the third access point based on the defined search window.

10. The method of claim 1, wherein:
the first access point comprises a femto node or a pico node; and
the second access point comprises a macro access point.

11. An apparatus for communication, comprising:
a distance determiner configured to determine a distance between a first access point and a second access point;
a search window definer configured to define a search window based on the determined distance; and
a receiver configured to search for at least one signal from the first access point based on the defined search window.

12. The apparatus of claim 11, wherein the definition of the search window comprises defining a center of the search window.

13. The apparatus of claim 11, wherein the definition of the search window comprises adjusting timing of a center of the search window according to a propagation delay time associated with the determined distance.

14. The apparatus of claim 11, further comprising a timing controller configured to acquire timing from the second access point, wherein timing of the search window is based on the acquired timing.

15. The apparatus of claim 11, wherein the determination of the distance comprises:
receiving a first indication of a location of the first access point;
receiving a second indication of a location of the second access point; and
calculating the distance based on the first and second indications.

16. The apparatus of claim 11, wherein the determination of the distance comprises receiving an indication of the distance.

17. The apparatus of claim 11, wherein the at least one signal comprises at least one pilot signal.

18. The apparatus of claim 11, further comprising:
a location determiner configured to determine a location of an access terminal; and
a search controller configured to determine whether to commence the search for the least one signal at the access terminal based on the determined location.

19. The apparatus of claim 11, wherein:
the distance determiner is further configured to determine another distance between a third access point and the second access point;
the search window definer is further configured to define the search window based on the determined another distance; and
the receiver is further configured to search for at least one other signal from the third access point based on the defined search window.

20. The apparatus of claim 11, wherein:
the first access point comprises a femto node or a pico node; and
the second access point comprises a macro access point.

21. An apparatus for communication, comprising:
means for determining a distance between a first access point and a second access point;
means for defining a search window based on the determined distance; and
means for searching for at least one signal from the first access point based on the defined search window.

22. The apparatus of claim 21, wherein the definition of the search window comprises defining a center of the search window.

23. The apparatus of claim 21, wherein the definition of the search window comprises adjusting timing of a center of the search window according to a propagation delay time associated with the determined distance.

24. The apparatus of claim 21, further comprising means for acquiring timing from the second access point, wherein timing of the search window is based on the acquired timing.

25. The apparatus of claim 21, wherein the determination of the distance comprises:
receiving a first indication of a location of the first access point;
receiving a second indication of a location of the second access point; and
calculating the distance based on the first and second indications.

26. The apparatus of claim 21, wherein the determination of the distance comprises receiving an indication of the distance.

27. The apparatus of claim 21, wherein the at least one signal comprises at least one pilot signal.

28. The apparatus of claim 21, further comprising:
means for determining a location of an access terminal; and
means for determining whether to commence the search for the least one signal at the access terminal based on the determined location.

29. The apparatus of claim 21, wherein:
the means for determining a distance is configured to determine another distance between a third access point and the second access point;
the means for defining a search window is configured to define the search window based on the determined another distance; and
the means for searching is configured to search for at least one other signal from the third access point based on the defined search window.

30. The apparatus of claim 21, wherein:
the first access point comprises a femto node or a pico node; and
the second access point comprises a macro access point.

31. A computer-program product, comprising:
computer-readable medium comprising codes for causing a computer to:
determine a distance between a first access point and a second access point;
define a search window based on the determined distance; and
search for at least one signal from the first access point based on the defined search window.

32. The computer-program product of claim 31, wherein the definition of the search window comprises defining a center of the search window.

33. The computer-program product of claim 31, wherein the definition of the search window comprises adjusting timing of a center of the search window according to a propagation delay time associated with the determined distance.

34. The computer-program product of claim 31, wherein:
the computer-readable medium further comprises codes for causing the computer to acquire timing from the second access point; and
timing of the search window is based on the acquired timing.

35. The computer-program product of claim 31, wherein the determination of the distance comprises:
receiving a first indication of a location of the first access point;
receiving a second indication of a location of the second access point; and
calculating the distance based on the first and second indications.

36. The computer-program product of claim 31, wherein the determination of the distance comprises receiving an indication of the distance.

37. The computer-program product of claim 31, wherein the at least one signal comprises at least one pilot signal.

38. The computer-program product of claim 31, wherein the computer-readable medium further comprises codes for causing the computer to:
determine a location of an access terminal; and
determine whether to commence the search for the least one signal at the access terminal based on the determined location.

39. The computer-program product of claim 31, wherein the computer-readable medium further comprises codes for causing the computer to:
determine another distance between a third access point and the second access point;
define the search window based on the determined another distance; and
search for at least one other signal from the third access point based on the defined search window.

40. The computer-program product of claim 31, wherein:
the first access point comprises a femto node or a pico node; and
the second access point comprises a macro access point.
